(19) United States
(12) Patent Application Publication
(10) Pub. No.: US 2004/0103554 A1
(43) Pub. Date: Jun. 3, 2004

(54) Dryer

(75) Inventor: Jong Chul Bang, Changwon-si (KR)

Correspondence Address: FLESHNER & KIM, LLP, P.O. BOX 221200, CHANTILLY, VA, 20153, US

(73) Assignee: LG Electronics Inc.

(21) Appl. No.: 10/721,248

(22) Filed: Nov. 26, 2003

(30) Foreign Application Priority Data
Nov. 28, 2002 (KR) P2002-75040

(51) Int. Cl. F26B 19/00

(52) U.S. Cl. 34/218

(57) ABSTRACT

Disclosed is a dryer enabling to switch a starting coil and a driving coil more simply. The present invention includes a cabinet, a drum, a heater, a converting switch, and a centrifugal switch. The centrifugal switch includes a body connected to a shaft of the motor to have loading recesses at an outside, a pair of balance weights having supports wherein one ends of the supports are inserted in the loading recesses, respectively, a pair of the balance weights revolving centering on the inserted one ends to be folded/unfolded, a plate provided to rear ends of the balance weights, and a return spring having both ends hooked on hanging portions of the balance weights to be fixed thereto.

This application claims the benefit of Korean Application(s) No. 10-2002-0075040 filed on Nov. 28, 2002 which is/are hereby incorporated by reference.

### BACKGROUND OF THE INVENTION

1. Field of the Invention

The present invention relates to a dryer enabling to switch a starting coil and a driving coil more simply.

2. Discussion of the Related Art

Generally, a dryer consists of a cabinet forming an exterior, a heater, a drum, and a motor. An object to be dried is held in the drum and air heated by the heater is blown into the drum to dry the object. In doing so, the motor rotates the drum to assist the object to be well brought contact with the heated air.

The drum usually holds a massive amount of objects to be dried, a high torque is needed to a rotation of an initial drive. Hence, a split phase stating motor generating the high torque is used as the motor.

The split phase starting motor has a starting coil and a driving coil separately. Power is applied to the driving coil to start the motor initially and is switched to the driving coil enabling a low torque rotation after completion of the initial start.

FIG. 1 is a diagram of a general driving circuit of a split phase starting motor.

Referring to FIG. 1, a split phase starting motor consists of a starting coil 1, a driving coil 2, and a converting switch 4.

The starting coil 1 generates a high torque and the driving coil 2 generates a low torque. And, the converting switch 4 applies AC current supplied from a power supply 3 to the starting coil 1 or the driving coil 2 selectively.

Hence, the starting coil 1 initiates a rotation of the motor at initial start. One the motor rotates over a predetermined rotational speed, the driving coil 2 drives the motor. Hence, the split phase starting motor reduces power consumption.

Namely, the AC current is supplied to the starting coil 1 generating a relatively high torque by the converting switch 4 at the initial start, and is switched to the driving coil 2 at operation needing no high torque.

However, the related art dryer has a very complicated construction of operating the converting switch for switching the starting coil and the driving coil to each other.

### SUMMARY OF THE INVENTION

Accordingly, the present invention is directed to a dryer that substantially obviates one or more of the problems due to limitations and disadvantages of the related art.

An object of the present invention, which has been devised to solve the foregoing problem, lies in providing a dryer, which enables to switch a starting coil and a driving coil more simply.

Additional features and advantages of the invention will be set forth in the description which follows, and in part will be apparent to those having ordinary skill in the art upon examination of the following or may be learned from a practice of the invention. The objectives and other advantages of the invention will be realized and attained by the subject matter particularly pointed out in the specification and claims hereof as well as in the appended drawings.

To achieve these objects and other advantages in accordance with the present invention, as embodied and broadly described herein, there is provided a dryer including a cabinet, a drum, a heater, a converting switch, and a centrifugal switch. And, the centrifugal switch includes a body connected to a shaft of the motor to have loading recesses at an outside, a pair of balance weights having supports wherein one ends of the supports are inserted in the loading recesses, respectively, a pair of the balance weights revolving centering on the inserted one ends to be folded/unfolded, a plate provided to rear ends of the balance weights, and a return spring having both ends hooked on hanging portions of the balance weights to be fixed thereto.

In this case, the loading recesses are rounded and one ends of the supports inserted in the loading recesses are rounded. Moreover, the dryer further includes a lever at a rear side of the plate to be connected to the converting switch.

The balance weights are unfolded to press the plate when the motor rotates over a predetermined rotational speed. And, the return spring has a predetermined elasticity folding the balance weights not to be brought contact with the plate when the motor rotates below a predetermined rotational speed.

Moreover, the dryer further includes a connector at a front end of the body to fix the body to the shaft of the motor.

In another aspect of the present invention, there is provided a centrifugal switch of a motor including a body connected to a shaft of a motor to have loading recesses at an outside, a pair of balance weights having supports wherein one ends of the supports are inserted in the loading recesses, respectively, a pair of the balance weights revolving centering on the inserted one ends to be folded/unfolded, a plate provided to rear ends of the balance weights, and a return spring having both ends hooked on hanging portions of the balance weights to be fixed thereto.

In this case, like elements of the centrifugal switch are equal to those of the dryer.

It is to be understood that both the foregoing explanation and the following detailed description of the present invention are exemplary and illustrative and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram of a general driving circuit of a split phase starting motor;

FIG. 2 is a cross-sectional view of a motor of a dryer according to one embodiment of the present invention;

FIG. 3A and FIG. 3B are cross-sectional views of a motor of a dryer according to one embodiment of the present invention for explaining an operation of a centrifugal switch;

FIG. 4 is a magnified view of ‘A’ in FIG. 3A;

FIG. 5 is a cross-sectional view of a centrifugal switch of a motor of a dryer according to another embodiment of the present invention; and

FIG. 6 is a magnified view of ‘B’ in FIG. 5B.

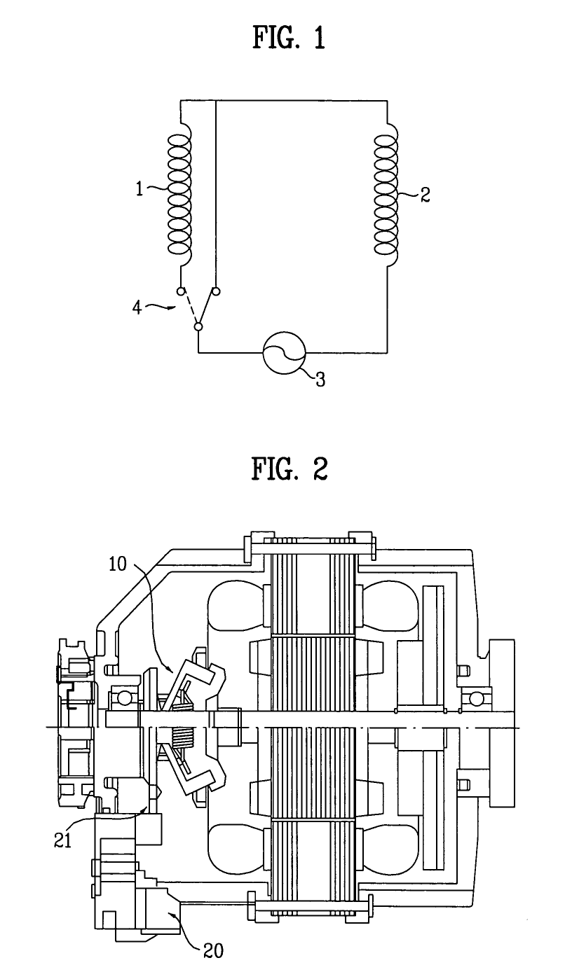

### DETAILED DESCRIPTION OF THE PREFERRED EMBODIMENT(S)

Reference will now be made in detail to the preferred embodiment(s) of the present invention, examples of which are illustrated in the accompanying drawings. Throughout the drawings, like elements are indicated using the same or similar reference designations where possible.

FIG. 2 is a cross-sectional view of a motor of a dryer according to one embodiment of the present invention.

Referring to FIG. 2, a motor of a dryer according to one embodiment of the present invention includes a converting switch 20, a centrifugal switch 10, and a lever 21.

The converting switch 20 switches power to a starting coil or a driving coil. The centrifugal switch 10 is provided to an outer conference of a motor haft to be turned on/off using centrifugal and elastic forces. The lever 21 connects the centrifugal switch 10 to the converting switch 20. If the centrifugal switch 10 fails to operate, the lever 21 is operated to supply power to the starting coil. If the centrifugal switch 10 operates, the lever 21 is operated to supply the power to the driving coil.

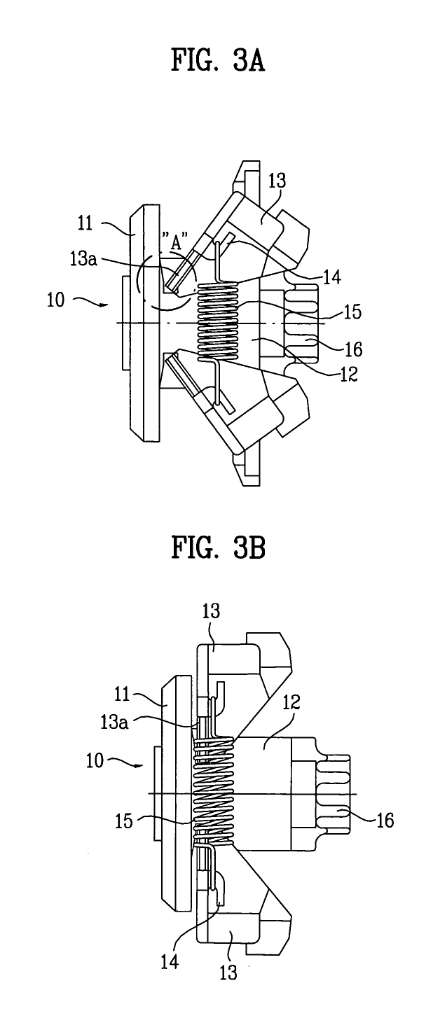

FIG. 3A and FIG. 3B are cross-sectional views of a motor of a dryer according to one embodiment of the present invention for explaining an operation of a centrifugal switch.

Referring to FIG. 3A and FIG. 3B, the centrifugal switch 10 includes a body 12, a plate 11, balance weights 13, and a return spring 15.

A connector 16 provided to a front end of the body 12 is fixed to a motor shaft. The plate 11 is installed vertical to the motor shaft at a rear end of the body 12. And, a pair of the balance weights 13 are provided to a lateral outside of the body 12 to be folded or unfolded. A support 13a is provided to a lower side of the balance weight 13 to extend long, and one end of the support 13a is rotatably fixed to an outside of the body 12.

Meanwhile, both ends of the return spring 15 are hung over hangers 14 formed at the balance weights 13, respectively. The return spring 15 pulls the balance weights 13 to fold at a predetermined angle to the motor shaft.

The centrifugal switch 10 operates the lever connected to the converting switch according to a rotational speed of the motor to switch the power to the starting or driving coil.

An operation of the centrifugal switch 10 according to the present invention is explained as follows.

Referring to FIG. 3A, the balance weights 13 maintain to be folded to a central portion by the elastic force of the return spring 15 at the initial start. In this case, the converting switch 20 keeps the power being connected to the starting coil.

FIG. 3B is a diagram of the centrifugal switch when the rotations speed of the motor increases.

Referring to FIG. 3B, as the rotational speed of the motor increases, the centrifugal force applied to the balance weights 13 increases. Hence, once the motor rotates over a predetermined rotational sped, the balance weights 13 diverge outward to press the plate 11. Simultaneously, the lever 21 connected to the plate 11 is pressed to switch the converting switch 20.

In this case, the converting switch 20 cuts of the power to the driving coil and connects the power to the driving coil to rotate the motor stably.

Meanwhile, when the motor rotates below the predetermined rotational speed, the centrifugal force working on the balance weights 13 decreases. Hence, a returning force of the return spring 15 folds the balance weights 13 to the central portion. In this case, the lever 21 is released from the pressed state and the converting switch 20 connects the power to the driving coil for a next start of the motor.

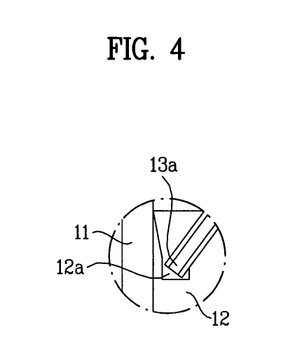

FIG. 4 is a magnified view of ‘A’ in FIG. 3A.

Referring to FIG. 4, the balance weights 13 rotate to be folded or unfolded centering on hinge points provided to the body 12, respectively. In this case, loading recesses 12a are formed at the outsides of the body 12 to play a role of the hinge points, respectively.

One ends of the supports 13a of the balance weights 13 are rotatably inserted in the loading recesses 12a. Hence, each of the balance weights 13 revolves centering on the one end of the support 13a fitted to the loading recess 12a of the body 12 to be folded/unfolded.

Meanwhile, the centrifugal switch according to one embodiment of the present invention is provided with tapered front ends of the loading recesses and supports, thereby failing to smoothly rotate but making noise.

A centrifugal switch of a motor of a dryer according to another embodiment of the present invention is described as follows.

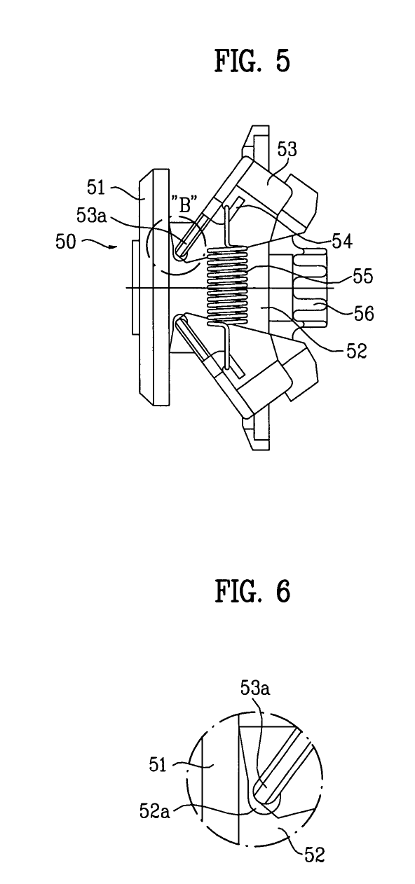

FIG. 5 is a cross-sectional view of a centrifugal switch of a motor of a dryer according to another embodiment of the present invention and FIG. 6 is a magnified view of ‘B’ in FIG. 5B.

Referring to FIG. 5 and FIG. 6, a centrifugal switch 50 according to another embodiment of the present invention includes a body 52, a plate 51, a pair of balance weights 53, and a return spring 55.

The body 52 is fixed to a motor shaft though a connector 56 so as to rotate with the motor shaft. The plate 11 is installed vertical to the motor shaft at a rear end of the body 52.

A pair of the balance weights 53 are provided to a lateral outside of the body 52 to be folded or unfolded. Both ends of the return spring 55 are hung over hangers 54 formed at the balance weights 53, respectively. The return spring 15 pulls the balance weights 53 to fold at a predetermined angle to the motor shaft.

In this case, loading recesses 52a are formed at the outsides of the body 52, and. One ends of supports 53a of the balance weights 53 are rotatably inserted in the loading recesses 52a. Hence, each of the balance weights 53 revolves centering on the one end of the support 53a fitted to the loading recess 52a of the body 52 to be folded/unfolded.

Meanwhile, one end of each of the supports 53a is rounded as well as the loading recess 52a is rounded. When the balance weight 53 rotates, one end of the support 53a rolls along an inner circumference of the loading recess 52a. Hence, the balance weights 53 rotate smoothly and makes less noise.

An operation of the centrifugal switch 50 according to another embodiment of the present invention is equal to that of one embodiment of the present invention but just differs in that the balance weights rotate more smoothly to secure a stable operation of the centrifugal switch.

Accordingly, the dryer according to the present invention has the following advantages or effects.

First of all, the present invention provides the simply constructed centrifugal switch to facilitate to operate the converting switch for switching connections between the power and the starting and driving coils.

Moreover, the present invention enables the balance weights of the centrifugal switch rotate smoothly, thereby securing a stable switching.

It will be apparent to those skilled in the art that various modifications and variations can be made in the present invention without departing from the spirit or scope of the invention. Thus, it is intended that the present invention cover such modifications and variations, provided they come within the scope of the appended claims and their equivalents.

What is claimed is:

1. A dryer comprising:
a cabinet;
a drum;
a heater;
a converting switch; and
a centrifugal switch comprising:
a body connected to a shaft of the motor to have loading recesses at an outside;
a pair of balance weights having supports wherein one ends of the supports are inserted in the loading recesses, respectively, a pair of the balance weights revolving centering on the inserted one ends to be folded/unfolded;
a plate provided to rear ends of the balance weights; and
a return spring having both ends hooked on hanging portions of the balance weights to be fixed thereto.

2. The dryer as claimed in claim 1, wherein the loading recesses are rounded and one ends of the supports inserted in the loading recesses are rounded.

3. The dryer as claimed in claim 1, further comprising a lever at a rear side of the plate to be connected to the converting switch.

4. The dryer as claimed in claim 1, wherein the balance weights are unfolded to press the plate when the motor rotates over a predetermined rotational speed.

5. The dryer as claimed in claim 1, wherein the return spring has a predetermined elasticity folding the balance weights not to be brought contact with the plate when the motor rotates below a predetermined rotational speed.

6. The dryer as claimed in claim 1, further comprising a connector at a front end of the body to fix the body to the shaft of the motor.

7. A centrifugal switch of a motor, comprising:
a body connected to a shaft of a motor to have loading recesses at an outside;
a pair of balance weights having supports wherein one ends of the supports are inserted in the loading recesses, respectively, a pair of the balance weights revolving centering on the inserted one ends to be folded/unfolded;
a plate provided to rear ends of the balance weights; and
a return spring having both ends hooked on hanging portions of the balance weights to be fixed thereto.

8. The centrifugal switch as claimed in claim 7, wherein the loading recesses are rounded and one ends of the supports inserted in the loading recesses are rounded.

9. The centrifugal switch as claimed in claim 7, further comprising a lever at a rear side of the plate to be connected to the converting switch.

10. The centrifugal switch as claimed in claim 7, wherein the balance weights are unfolded to press the plate when the motor rotates over a predetermined rotational speed.

11. The centrifugal switch as claimed in claim 7, wherein the return spring has a predetermined elasticity folding the balance weights not to be brought contact with the plate when the motor rotates below a predetermined rotational speed.

12. The centrifugal switch as claimed in claim 7, further comprising a connector at a front end of the body to fix the body to the shaft of the motor.
